(19) United States
(12) Patent Application Publication
(10) Pub. No.: US 2016/0116050 A1
(43) Pub. Date: Apr. 28, 2016

(54) PULLEY DEVICE FOR A CHAIN OR BELT AND MOTOR VEHICLE EQUIPPED WITH SUCH A DEVICE

(71) Applicant: Benoit ARNAULT, Saint-Cyr-sur-Loire (FR)

(72) Inventor: Benoit ARNAULT, Saint-Cyr-sur-Loire (FR)

(73) Assignee: Aktiebolaget SKF, Göteborg (SE)

(21) Appl. No.: 14/884,814

(22) Filed: Oct. 16, 2015

(30) Foreign Application Priority Data
Oct. 24, 2014 (FR) 1460265

(51) Int. Cl. F16H 55/36; F16C 19/54; F16C 19/16

(52) U.S. Cl. CPC F16H 55/36; F16C 19/166; F16C 19/548

(57) ABSTRACT

A pulley device for one of a chain or belt; the pulley device includes two rolling bearings, each having an inner ring, an outer ring rotatable relative to the inner ring around a shared central axis, and a row of rolling elements mounted in a rolling chamber defined between the inner ring and an outer ring. A pulley is secured in rotation with the outer rings of the two rolling bearings and provided with an outer radial surface for engaging with one of a chain or a belt. The pulley device also includes a feature for exerting an axial load parallel to the shared central axis onto the outer rings. The axial load urges the outer rings one toward the other, or opposite one another.

### CROSS REFERENCE TO RELATED APPLICATION

This is a Non-Provisional Patent Application, filed under the Paris Convention, claiming the benefit of France (FR) Patent Application Number 1460265, filed on 24 Oct. 2014 (24.10.2014), which is incorporated herein by reference in its entirety.

### FIELD OF THE INVENTION

The invention relates to a pulley device as used, in particular, in motor vehicles. Such a device may relate to tension rollers for stretching a chain or belt for transmitting movement, accessory rollers, winders, loose pulleys and any other means for support and transmitting rotation.

### PRIOR ART

In this type of device, it is known, for example from FR-A-2,706,726, to use two rows of beads that cooperate with two rings made in metal plates to support a pulley. It is also known from FR-A-2,970,755 and FR-A-2,971,028 to use two rows of beads cooperating with thin-walled rings made by stamping a metal sheet, within a belt tension roller device or a loose pulley device.

With this type of material, and in order to avoid premature wear of the rolling elements, it is necessary to match the beads and the rings, or to use rigid rings, i.e., massive, and consequently, relatively expensive.

### BRIEF DESCRIPTION OF THE PRESENT INVENTION

The invention more particularly aims to resolve these drawbacks by proposing a new pulley device that is cost-effective to manufacture and that has satisfactory mechanical properties, including in the case where those inner and outer rings are relatively thin.

To that end, the invention relates to a pulley device for a chain or belt, the device comprising two rolling bearings each having an inner ring, an outer ring rotatable relative to the inner ring around a shared central axis, and a row of rolling elements mounted in a rolling chamber defined between the inner ring and an outer ring. This device also comprises a pulley secured in rotation with the outer rings of the two rolling bearings and provided with an outer radial surface for engaging with a chain or a belt. According to the invention, the pulley device comprises a feature for exerting on the outer rings an axial load parallel to the shared central axis, this axial load urging the outer rings one toward the other, or opposite one another.

Owing to the invention, the axial load exerted on the outer rings makes it possible to react the manufacturing play, which may in particular result from the low rigidity of the inner and outer rings, but also from other factors related to the other components of the pulley device, in particular expansion phenomena.

Within the meaning of the present invention, the word “axial” relates to the shared central axis of the device, which constitutes a relative rotation axis between the inner and outer rings. A direction or a force is axial when it is parallel to that axis and radial when it is perpendicular and secant to that axis. A surface is axial when it is perpendicular to an axial direction and radial when it is perpendicular to a radial direction.

According to advantageous, but optional aspects of the invention, such a pulley device may incorporate one or more of the following features, considered in any technically admissible combination:
The rolling bearings use oblique contact, with contact directions converging as they approach the shared central axis, while an axial load force tends to bring the outer rings closer to one another.
The rolling bearings use oblique contact, with contact directions that diverge as they approach the shared central axis, while an axial load force tends to separate the outer rings from one another.
The inner and outer rings of the rolling bearings are formed by strips of stamped sheet metal.
The axial load feature comprises an axial stop arranged on the pulley and adapted to receive in contact a first outer ring, among the outer rings of the two rolling bearings, by bearing, and an elastic urging member bearing on the second ring toward the axial stop of the pulley.
The pulley device comprises an axial locking element for the elastic member relative to the pulley.
The elastic bearing member is an elastically deformable corrugated washer, bearing against a side surface of the second outer ring, while the axial locking element is a retaining ring engaged in an inner radial groove of the pulley.
The axial load feature comprises two stops arranged and/or attached on the pulley and each able to receive in contact, by bearing, an outer ring of the rolling bearings, while an elastic member is positioned axially between the two outer rings and bearing against those two rings.
The two inner rings of the rolling bearings bear axially against one another and the two outer rings exert an axial compression force on the elastic member.
The pulley device further comprises a spacer for transmitting an axial load force between the inner rings of the two rolling bearings.
The pulley device comprises a screw for assembly on a support, that screw being housed radially inside the inner rings, while the spacer is provided and configured to undergo an axial compression force resulting from the assembly of the pulley device on the support, that force resulting in blocking the rotation of the inner rings relative to the spacer.
The spacer is provided with a passage channel for a power cable of a sensor.
The inner rings of the two rolling bearings are formed by a single piece.
Each ring comprises a track in contact with the rolling elements and a planar annular part, perpendicular to the shared central axis, while an axial load force is applied between the planar annular parts of the two outer rings.

The invention also relates to a motor vehicle equipped with a pulley device as described above and a chain or belt bearing on the outer radial surface of the pulley of that device.

### BRIEF DESCRIPTION OF THE DRAWINGS

The invention will be better understood and other advantages thereof will appear more clearly in light of the following description of two embodiments of a pulley device and a motor vehicle according to its principle, provided solely as an example and done in reference to the appended drawings, in which:

FIG. 1 is a sectional view of a pulley device according to the invention, in place on a support belonging to a motor vehicle according to the invention;

FIG. 2 is an enlarged half-sectional view corresponding to the upper part of FIG. 1, in which only the pulley device is shown and the screw that it comprises is omitted;

FIG. 3 is a perspective view of an elastic washer used in the pulley device of FIGS. 1 and 2; and

FIG. 4 is a view similar to FIG. 2 for a pulley device according to a second embodiment of the invention.

### DETAILED DESCRIPTION OF THE PRESENT INVENTION

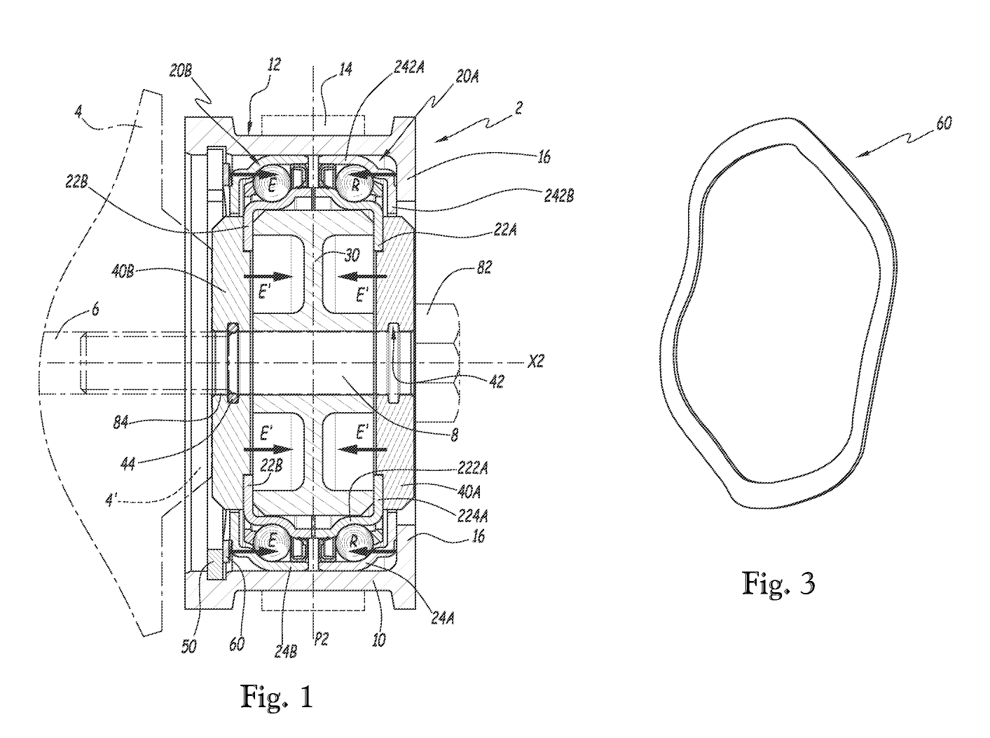

The pulley device 2 shown in FIGS. 1 to 3 is a loose pulley designed to be mounted on an engine block 4, which is equipped with a tapping 6 for receiving a screw 8 belonging to the pulley device 2. The engine block 4 belongs to a motor vehicle that is shown in FIG. 1.

The pulley device 2 comprises a pulley 10 that rotates freely around a central axis X2 and for which reference 12 denotes the outer radial surface on which a belt 14, shown in mixed lines and only in FIG. 1, bears.

Alternatively, the pulley 10 can receive, on its outer radial surface 14, a chain.

The pulley 10 is supported in rotation around the axis X2 owing to two ball bearings 20A and 20B, which are identical. The rolling bearing 20A comprises a non-rotary inner ring 22A, a rotary outer ring 24A and a row of beads 26A positioned in a rolling chamber 28A arranged radially between the rings 22A and 24A. A cage 29A made from a synthetic material keeps the beads 26a in position inside the rolling chamber 28A, in a manner known in itself.

The rings 22A and 22B are normally mounted gripped in the bore of the pulley 10. This gripping is necessary to prevent these stamped outer rings 22A and 22B from rotating in the housing. This phenomenon is called “rolling”. In general, the adjustment of the connection between the parts 10, 22A and 22B with gripping remains necessary even if the rings 22A and 22B are gripped laterally.

The rings 22A and 24A are made by stamping strips of sheet metal whose thickness is comprised between 0.3 and 10 mm. In the case of large rolling bearings, this thickness can be equal to 50 mm, or even 100 mm.

The ring 22A comprises a part 222A that defines a rolling track for the beads 26A, as well as a part 224A that is planar, annular and perpendicular to the axis X2 Likewise, the ring 24A comprises a rolling track 242A and a part 244A that is planar, annular and perpendicular to the axis X2. The rings 22A and 24A are each in a single piece. A sealing gasket 27A is positioned between the rings 22A and 24A, on the side of the rolling bearing 20B, and comprises a framework 272A and an elastomer body 274A.

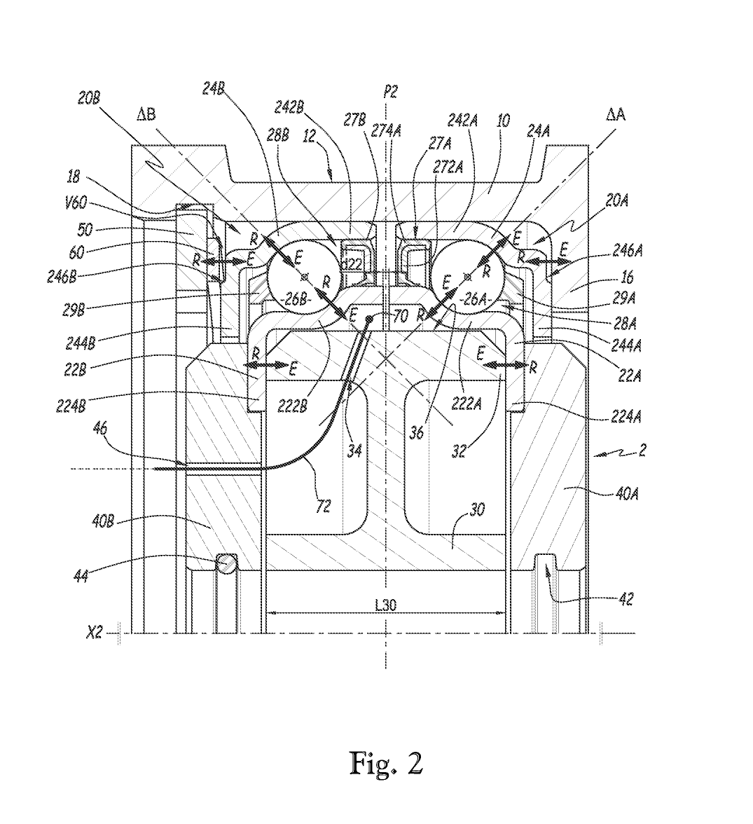

Reference ΔA denotes a straight line passing through the centers of the rolling tracks 222A and 242A and through the center of the beads 26A, in the plane of FIG. 2. This line ΔA is inclined by approximately 45° relative to the axis X2.

Reference P2 denotes a plane radial to the axis X2 and passing between the rolling bearings 20A and 20B. The line ΔA approaches the plane P2 at the same time that it approaches the axis X2.

Likewise, the rolling bearing 20B comprises a non-rotary inner ring 22B, a rotary outer ring 24B, beads 26B, a rolling chamber 28B, a cage 29B and a seal 27B. The rings 22A and 22B each break down into a part 222B or 224B forming a rolling track and a planar part 224B or 244B, annular and perpendicular to the axis X2. A straight line ΔB is defined passing through the respective centers of the rolling tracks 222B and 242B and through the center of the beads 26B in the plane of FIG. 2. The line ΔB is symmetrical to the line ΔA relative to the plane P2. The lines ΔA and ΔB converge toward one another as they come closer to the axis X2.

Thus, the two rolling bearings 20A and 20B are in oblique contact and may be considered to have an “X” configuration regarding the orientation of the contact surfaces between the beads 26A and 26B and the adjacent rings.

The rolling bearings 20A and 20B are of the “antifriction bearing” or “clutch bearing unit” type, as sometimes used in motor vehicle clutch/declutching mechanisms, known from FR-A-2,992,383.

The pulley device 2 also comprises a spacer 30 positioned, axially along the axis X2, between the parts 224A and 224B of the inner rings 22A and 22B. This spacer 30 is made from metal. It is made by machining, stamping, sintering, or forging.

Alternatively, the spacer 30 can be made from plastic and, in that case, it can be obtained by molding.

The device 2 also comprises two plates 40A and 40B globally in the shape of disks and each provided with a central passage orifice for the screw 8. The plate 40A is positioned on the side of the rolling bearing 20A and is designed to receive the head 82 of the screw 8 by bearing. The plate 40B is positioned on the side of the rolling bearing 20B and it is designed to bear against a boss 4′ that is part of the engine block 4 and at the center of which the tapping 6 is arranged. The plates 40A and 40B are identical and each provided with an inner radial groove 42. An O-ring 44 is positioned in the groove 42 of the plate 40B and bears rubbing against the thread 84 of the screw 8.

The pulley 10 is provided, on the side of the rolling bearing 20A, with a side annular wall 16 that extends toward the axis X2 against which the part 244A of the ring 24A bears.

Furthermore, the pulley 10 is provided with an inner peripheral groove 18 in which a retaining ring 50 is housed.

A corrugated washer 60, elastically deformable, sometimes called “flat spring”, is positioned, along the axis X2, between the retaining ring 50 and the part 244B. The elastically deformable washer surrounds the plate 40B and the screw 8 in the mounted configuration of the pulley device 2.

In this configuration, the washer 60 exerts, on the ring 24B, an axial elastic force E oriented toward the wall 16. This force E is transmitted by the ring 24B to the beads 26B and, in light of the orientation of the line ΔB, to the ring 24A. The force E is then transmitted, by the part 224B of the ring 24B, to the spacer 30. The spacer 30 transmits that force E to the part 224A of the ring 22A, which transmits it to the beads 26A and, through them and along the line ΔA, to the ring 24A, which transmits it to the wall 16. In FIG. 2, the arrows E represent the elastic force exerted by the corrugated washer 60 on the two rolling bearings 20B and 20A, up to the wall 16. Inasmuch as the axial position of the pulley 10 relative to the washer 60 is determined by the retaining ring 50 received in the groove 18, the wall 16 exerts a reaction force R also shown in that figure, that force having an intensity equal to that of the force E and a direction opposite that force at the interface with the parts 24A and 30. Thus, the elastic force E exerted by the washer 60 results in an axial load of the outer rings 24A and 24B one toward the other, owing to the combination of forces E and R, which results in reacting the assembly and machining play within the rolling bearings 20A and 20B and between the parts 10 and 30.

It will be noted in FIG. 2 that the plates 40A and 40B are not in axial contact with the spacer 30, but that they pinch the parts 224A and 224B against the outer radial web 32 of that spacer. Indeed, the tightening of the screw 8 in the tapping 6 results in the head 82 pushing the plate 40A toward the boss 4′ against which the plate 40B bears. The plates 40A and 40B then undergo an axial load force E′ shown only in FIG. 1, that force tending to bring the plates 40A and 40B against one another while pinching the parts 224A and 224B against the web 32 of the spacer 30. The spacer 30 is thus compressed by the force E′ between the plates 40A and 40B.

Thus, the inner plates 22A and 22B are immobilized relative to the non-rotary part of the device 2 that comprises the screw 8, the spacer 30 and the plates 40A and 40B.

The axial length of L30 of the spacer 30 is chosen such that the inner rings 22A and 22B are separated by a non-zero distance d22, that distance being measured, parallel to the axis X2, between the parts 222A and 222B. This prevents the rings 22A and 22B from having to work against one another in compression.

However, alternatively, the rings 22A and 22B can be in axial contact.

FIG. 2 shows that the edges of the parts 224A and 224B turned toward the axis X2 are not in contact with the plates 40A and 40B. Alternatively, the rings 22A and 22B are mounted gripped against the plates 40A and 40B.

According to one alternative of the invention that is not shown, the two rings 22A and 22B can be made by a single strip of bent sheet metal. In that case, the geometry of the spacer 30 is adapted.

In place of the corrugated washer or flat spring 60, it is possible to use a washer made from an elastomeric material or an elastic member crimped on the pulley 10. In that case, it is not essential to use the retaining ring 50.

According to one aspect of the invention shown in FIG. 2, the spacer 30 is provided with a channel 34 that emerges on its outer radial surface 36 and that allows the passage of a power cable 72 for a temperature sensor 70. This sensor is positioned near the plane P2, between the inner rings 22A and 22B and the surface 36. It makes it possible to detect the temperature near the rings. In that case, the plate 40B is equipped with a duct 46 for passage of the cable 72 and a corresponding orifice, not shown, is provided in the boss 4′. In practice, since the plates 40A and 40B are identical, a duct 46 is provided in each of those plates, that duct not being visible in the plate 40A in FIG. 2 owing to the angular orientation of that plate around the axis X2.

The rings 24A and 24B are each provided with a shoulder 246A, 246B, respectively, on the outer surface of their part 244A or 244B. For the ring 24A, this shoulder is not actually used. For the ring 24B, this shoulder makes it possible to center the corrugated washer 60 relative to the axis X2, by defining a volume V60 for partially receiving that washer.

According to one alternative of the invention that is not shown, the washer 60 can be centered in the bore of the pulley 10, thus eliminating the presence of the shoulders 246A and 246B of the ring 24A and 24B.

The fact that the parts 24B and 60 are not in contact in the illustration of FIG. 2 is due to the corrugated nature of the washer 60. In the plane of FIG. 2, a corrugation of the washer 60 is in contact with the retaining ring 50 and axially separated from the ring 24B. In another radial plane, it is the opposite: the corrugation is in contact with the ring 24B and separated from the retaining ring 50.

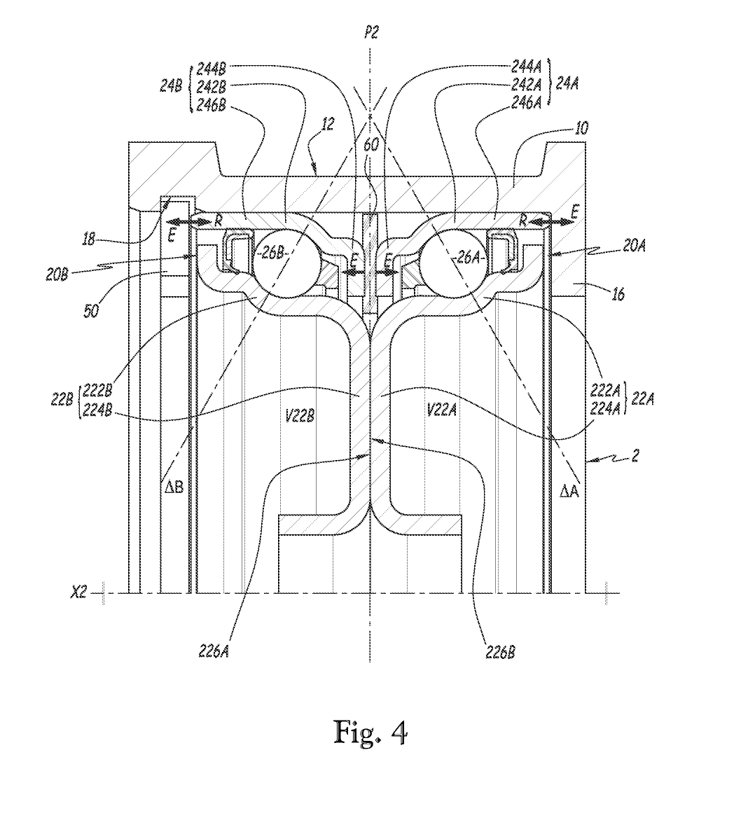

In the second embodiment shown in FIG. 4, the elements similar to those of the first embodiment bear the same references.

This embodiment differs from the previous one in particular in that the two rolling bearings 20A and 20B of the device 2, which are in oblique contact like those of the first embodiment, can be considered to have an “O” configuration regarding the orientation of the contact surfaces between the beads 26A and 26B and the adjacent rings 22A, 24A, 22B, 24B of the rolling bearings 20A and 20B.

As in the first embodiment, reference ΔA denotes a straight line passing through the respective centers of the rolling tracks 222A and 242B and through the center of the beads 26A, in the plane of FIG. 4. This line is inclined by approximately 60° relative to the axis X2. Reference ΔB also denotes a straight line passing through the respective centers of the rolling tracks 222B and 242B and through the center of the beads 26B in the plane of FIG. 4. As in the first embodiment, reference P2 denotes a plane radial to the axis X2 and passing between the rolling bearings 20A and 20B.

The lines ΔA and ΔB are symmetrical to one another relative to the plane P2 and divergent from one another approaching the axis X2. In that sense, the four lines ΔA and ΔB that may be defined for the entire device 2, in an illustration similar to that of FIG. 1, approximately form a diamond- or “O”-shaped structure.

In this embodiment, the outer rings 22A and 22B are each provided with a flat annular surface 226A, 226B. These surfaces 226A and 226B bear against one another at the plane P2.

An elastic washer, for example made from elastomer or a plastic material, is positioned axially between the planar annular parts 244A and 244B of the outer rings 24A and 24B.

The rolling track 242A of the outer ring 24A extends, opposite the part 244A, in the form of a cylindrical portion 246A that bears against a side annular wall 16 of the pulley 6, similar to that of the first embodiment. Furthermore, the rolling track 242B of the ring 24B extends, opposite the part 244B, by a cylindrical part 246B that bears against a retaining ring 50 engaged in an inner annular groove 18 of the pulley 10, as in the first embodiment.

Thus, in the assembled configuration of the device 2, the surfaces 226A and 226B bear axially against one another and the cylindrical parts 246A and 246B respectively bear axially against the wall 16 and the retaining ring 50, such that the planar annular parts 244A and 244B of the rings 24A and 24B exert a compression force on the elastic washer 60. This compression force is absorbed by the ring 60, which exerts, in reaction, an elastic force E that presses the parts 246A and 246B, respectively, against the wall 16 and against the retaining ring 50. This elastic force E therefore makes it possible to absorb the deviations of the sides due to the machining allowances and expansion phenomena, in particular thermal expansion.

In reaction, the parts 16 and 50 exert a reaction force R oriented toward the plane P2 on the rings 24A and 24B.

It will be noted that the surfaces 226A and 226B have a radial width, vertical in FIG. 4, that is relatively significant, to the point that inside each of the inner rings 22A and 22B, a volume V22A or V22B is defined in which accessories such as sensors can be housed. These accessories can in particular be fastened on the surfaces of the planar part 224A and 224B opposite the surfaces 226A and 226B. These surfaces on which the accessories can be mounted also make it possible to dissipate heat.

In place of the beads 26A and 26B, the rolling elements can be positioned between the inner and outer rings of the rolling bearings 20A and 20B, in particular rollers or needles.

The invention is described above in the context of its implementation for a loose pulley. It is, however, applicable with other pulley devices, in particular a tension roller, an accessory roller, or a chain or belt stretcher.

The embodiments and alternatives considered above may be combined with one another to create new embodiments of the invention.

What is claimed is:

1. A pulley device for one of a chain or belt, the pulley device comprising:
two rolling bearings each rolling bearing having:
an inner ring,
an outer ring rotatable relative to the inner ring around a shared central axis, and
at least one row of rolling elements mounted in a rolling chamber defined between the inner ring and the outer ring,
a pulley secured in rotation with the outer rings of the two rolling bearings and provided with an outer radial surface for engaging with one of a chain or a belt; and
a feature for exerting an axial load parallel to the shared central axis onto the outer rings, the axial load urging the outer rings in one of the following directions:
(a) one toward the other, or
(b) opposite one another.

2. The device according to claim 1, wherein the rolling bearings use oblique contact, with contact directions converging as they approach the shared central axis, and in that an axial load force tends to bring the outer rings closer to one another.

3. The device according to claim 1, wherein the rolling bearings use oblique contact, with contact directions that diverge as they approach the shared central axis, and in that an axial load force tends to separate the outer rings from one another.

4. The device according to claim 1, wherein the inner ring and the outer ring of the rolling bearings are formed by strips of stamped sheet metal.

5. The device according to claim 1, the axial load applying feature comprises:
an axial stop arranged on the pulley and adapted to receive in contact a first outer ring, among the outer rings of the two rolling bearings; and
an elastic bearing member urging the second ring, among the outer rings of the two rolling bearings, toward the axial stop of the pulley.

6. The device according to claim 5, further comprising an axial locking element for the elastic member relative to the pulley.

7. The device according to claim 6, wherein the elastic bearing member is an elastically deformable corrugated washer, bearing against a side surface of the second outer ring,
wherein the axial locking element is a retaining ring engaged in an inner radial groove of the pulley.

8. The device according to claim 1, the axial load feature comprises:
two axial stops at least one of arranged and attached on the pulley and each axial stop able to receive in contact a first outer ring of the rolling bearings; and
an elastic member positioned axially between the two outer rings and bearing against those two rings.

9. The device according to claim 8, wherein the two inner rings of the rolling bearings bear axially against one another,
wherein the two outer rings exert an axial compression force on the elastic member.

10. The device according to claim 1, further comprising:
a spacer for transmitting an axial load force between the inner rings of the two rolling bearings.

11. The device according to claim 10, further comprising:
a screw for assembly on a support, the screw being housed radially inside the inner rings, and in that the spacer is provided and configured to undergo an axial compression force resulting from the assembly of the pulley device on the support, the force resulting in blocking the rotation of the inner rings relative to the spacer.

12. The device according to claim 10, the spacer further comprises a passage channel for a power cable for a sensor.

13. The device according to claim 1, wherein the inner rings of the two rolling bearings are formed by a single piece.

14. The device according to claim 1, each ring further comprises a track in contact with the rolling elements and a planar annular part, perpendicular to the shared central axis, and in that an axial load force is applied between the planar annular parts of the two outer rings.

15. A motor vehicle equipped with a pulley device, the pulley device comprising:
two rolling bearings each rolling bearing having:
an inner ring,
an outer ring rotatable relative to the inner ring around a shared central axis, and
at least one row of rolling elements mounted in a rolling chamber defined between the inner ring and the outer ring,
a pulley secured in rotation with the outer rings of the two rolling bearings and provided with an outer radial surface for engaging with one of a chain or a belt; and
a feature for exerting an axial load parallel to the shared central axis onto the outer rings, the axial load urging the outer rings in one of the following directions:
(a) one toward the other, or
(b) opposite one another; and
one of a chain or a belt bearing on an outer radial surface of the pulley of the pulley device.
